(19) United States
(12) Patent Application Publication
(10) Pub. No.: US 2011/0191408 A1
(43) Pub. Date: Aug. 4, 2011

(54) SYSTEM FOR CONTENT DELIVERY OVER A TELECOMMUNICATIONS NETWORK

(75) Inventor: William Robert Barlow, Grosse Pointe, MI (US)

(73) Assignee: MOVIESYNC, INC, Grosse Pointe, MI (US)

(21) Appl. No.: 13/019,349

(22) Filed: Feb. 2, 2011

Related U.S. Application Data
(60) Provisional application No. 61/300,476, filed on Feb. 2, 2010.

(51) Int. Cl. G06F 15/16

(52) U.S. Cl. 709/203; 709/219

(57) ABSTRACT

A content delivery system includes a client configured for communication with a server and a display. The client includes program code for requesting content from the server, the content comprising a plurality of related objects at discrete locations in a memory accessible by the server. The client further includes program code for receiving index information from the server regarding the content. The client further includes code for determining an order for requesting the objects from the server responsive to the index information. The client further includes code for requesting a first object of the plurality of objects based on the order and for requesting a second object of the plurality of objects based on the order while simultaneously generating output to the display based on the first object.

### CROSS REFERENCE TO RELATED APPLICATIONS

This application claims the benefit of a provisional patent application of the same title filed Feb. 2, 2010 having application Ser. No. 61/300,476.

### BACKGROUND OF THE INVENTION

1. Field of the Invention

This invention relates to distribution and delivery of content over a telecommunications network and, more particularly, to a content delivery system enabling efficient delivery of content and simultaneous receipt and display of content.

2. Disclosure of Related Art

In-home entertainment and other types of content are frequently delivered to users through purchase or rental of recordable media (e.g. a digital video disc (DVD)) on which the content is stored. In recent years, an ever increasing breadth of content has been delivered directly to users through telecommunication networks. For some forms of content, delivery requires downloading all portions of the desired content prior to viewing or other use of the content. In recent years, however, more content has been delivered by “streaming” the content or by progressive download such that users can simultaneously receive and use the content. Some form of streaming content has been available for many years (e.g., the streaming of television shows and movies broadcast on television and/or cable networks). More recently, however, with the substantial growth of broadband access, streaming has been used to provide “on demand” delivery of content (e.g., pay-per-view (PPV) or video-on-demand (VOD)) to a variety of display systems.

Streaming content represents a significant improvement relative to earlier forms of content delivery, but has failed to achieve optimal delivery of that content. First, streaming content frequently fails to provide users with the full spectrum of content they can obtain from other sources. Movies distributed on DVDs, for example, are frequently combined with additional content such as alternative endings, information on the making of the movie, games, actor biographies, scene selection, alternate languages, etc. Further, the user is able to move relatively seamlessly between the content using conventional DVD players. Movies that are delivered as streaming content or by progressive download generally lack this additional content which must be separately obtained and the content that is received is typically compressed and lacks the quality of content found on recordable media. Second, streaming content is often inefficient. For example, a movie viewer may wish to jump to different points in time within a movie (including, for example, actions such as “fast forward” or “rewind”), but some systems implementing streaming content prevents this type of action. Other systems permit the user to jump to a different point in time, but require the content stream to be downloaded again into a buffer beginning from that point in time (while discarding the initial download from the buffer). As another example, the user of a software program may not require the entire program. Based on inputs by the user or other parameters, the user may use or require only certain features of the program. As noted above, conventional systems for delivering streaming content will either download all portions of the program whether or not they are ultimately needed or used or will require a new download into the buffer based on the user input (and a corresponding discard of the prior download).

The inventor herein has recognized a need for a content delivery system that will minimize and/or eliminate one or more of the above-identified deficiencies.

### SUMMARY OF THE INVENTION

The present invention provides a content delivery system.

A content delivery system in accordance with the present invention includes a client configured for communication with a server and a display. The display may comprise a television screen(CRT, LCD, etc.), a computer monitor or other conventional display. The client may be integrated with the display or separately housed (e.g., in the manner of “set-top” box). The client includes program code for requesting content from the server. The content may comprise, for example, an audiovisual work or a software program. The content comprises a plurality of related objects at discrete locations in a memory accessible by the server. The client further includes code for receiving index information from the server regarding the content. The index information may comprise a memory address, a functional description of the object, or the file type, file name, or file size of the object. The client further includes code for determining an order for requesting the plurality of objects from the server responsive to the index information. The client further includes code for requesting a first object of the plurality of objects based on said order and for requesting a second object of the plurality of objects based on the order while simultaneously generating output to the display based on the first object.

A content delivery system in accordance with the present invention has significant advantages relative to conventional systems. First, the inventive system enables delivery over a telecommunications network of the full spectrum of content and features associated with that content currently available only on recordable media. Second, the inventive system makes delivery of content more efficient by enabling transmission of only selected portions of content.

These and other advantages of this invention will become apparent to one skilled in the art from the following detailed description and the accompanying drawings illustrating features of this invention by way of example.

### BRIEF DESCRIPTION OF THE DRAWINGS

FIG. 1 is a diagrammatic view of one embodiment of a system in accordance with the present invention.

FIG. 2 is a diagrammatic view of the hardware architecture for the client component of the system of FIG. 1.

FIG. 3 is a diagrammatic view of the software architecture for the client component of the system of FIG. 1.

FIGS. 4A-B are a flow chart diagram illustrating operation of one embodiment of a system in accordance with the present invention.

### DETAILED DESCRIPTION OF EMBODIMENTS OF THE INVENTION

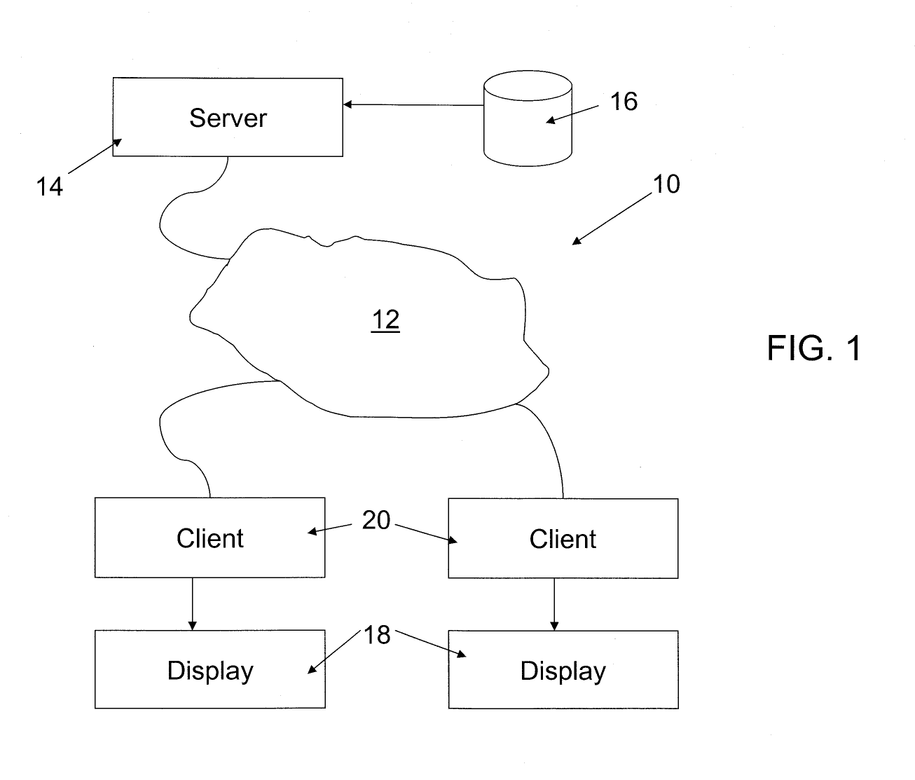

Referring now to the drawings wherein like reference numerals are used to identify identical components in the various views, FIG. 1 illustrates a system 10 in accordance with the present invention. System 10 is provided to enable efficient delivery of content over a telecommunications network 12. The content may comprise “end use” content such as a movie, a sound recording, or a computer game. In one embodiment of the invention, the content comprises audiovisual works and, in particular, movies and associated content (e.g., alternate endings, information on the making of the movie, games, actor biographies, etc.) commonly found on DVDs. It should be understood, however, that a wide variety of end use content could be delivered using system including, for example, music videos, broadcast television shows, advertisements, etc. The content may also comprise software programs and other forms of content useful in manipulating end use content. In particular, the content may comprise a software program useful in the downloading and/or managing end use content. Network 12 comprises the public internet in one embodiment of the invention. It should be understood, however, that network 12 may alternatively comprise a local area network (LAN), wide area network (WAN), virtual private network (VPN) or form of telecommunications network and that network 12 may comprise an intranet or extranet. System 10 may include a server 14, a database 16, and one or more displays 18 and clients 20.

Server 14 is provided to handle delivery of content to clients 20 through network 12. As used herein, the term “server” refers to a computing device coupled to a network and configured by programming instructions (i.e., software) to provide services to other computing devices (including other servers). Server 14 may include a conventional operating system such as one of the operating systems sold under the registered trademark “WINDOWS®” available from Microsoft Corporation of Redmond, Washington. It should be understood, however, that other conventional operating systems such as those based on the Linux or UNIX operating systems or operating systems for the Apple computer system (e.g. OS X) may alternatively be used. Server 14 may also include an internal memory or database configured to provide a static and dynamic contact structure for server 14. The database is used to provide both intermediate information while server 14 executes operations and long-term storage of data. The database may employ a database management system (DBMS) such as the DMBS sold under the trademark “SQL SERVER” by Microsoft Corporation of Redmond, Wash. Server 14 further includes applications that configure server 14 to perform the functions described in greater detail hereinafter. The applications may be implemented using conventional software development components and may further include a combination of JavaScript, VB Script and ASP (Active Server Pages) and other conventional software components to provide required functionality. Server 14 also includes a conventional interface to provide a graphical and communications interface between server 14 and clients 20. The interface may, for example, be configured to be eXtensible Markup Language (XML) or Simple Object Access Protocol (SOAP) compliant. Although only one server 14 is shown in the illustrated embodiment, it should be understood that system 10 could include multiple servers working cooperatively in one or more known computing architectures.

Database 16 provides a structured memory to store content for delivery by server 14 to clients 20 across network 12. Database 16 is conventional in the art. The particular form or hierarchy of database 16 and the use of any specific type of database management system will be dependent on the type of data stored in database 16 as is known in the art. In one embodiment of the invention, database 16 stores information regarding movies available using system 10 including the memory location for files associated with the movie and bibliographic information such as the release year, director, actors, rating, etc. It should be understood that database 16 may be unnecessary for some applications of system 10 in that content can be stored in the database or memory of server 14 depending on the nature and volume of content. It should also be understood that multiple databases could be used and accessible by server 14 depending again on the types and amount of content to be delivered.

Displays 18 are provided for the display of certain forms of content including, e.g., movies or other audiovisual works. Displays 18 are conventional in the art and may comprise television screens (e.g., a cathode ray tube (CRT) or liquid crystal display (LCD)) in one embodiment of the invention. It should be understood, however, that displays 18 may comprise any conventional mechanism for displaying visual images and/or graphics including computer monitors and display screens associated with personal digital assistants (PDAs), cellular phones and similar technologies.

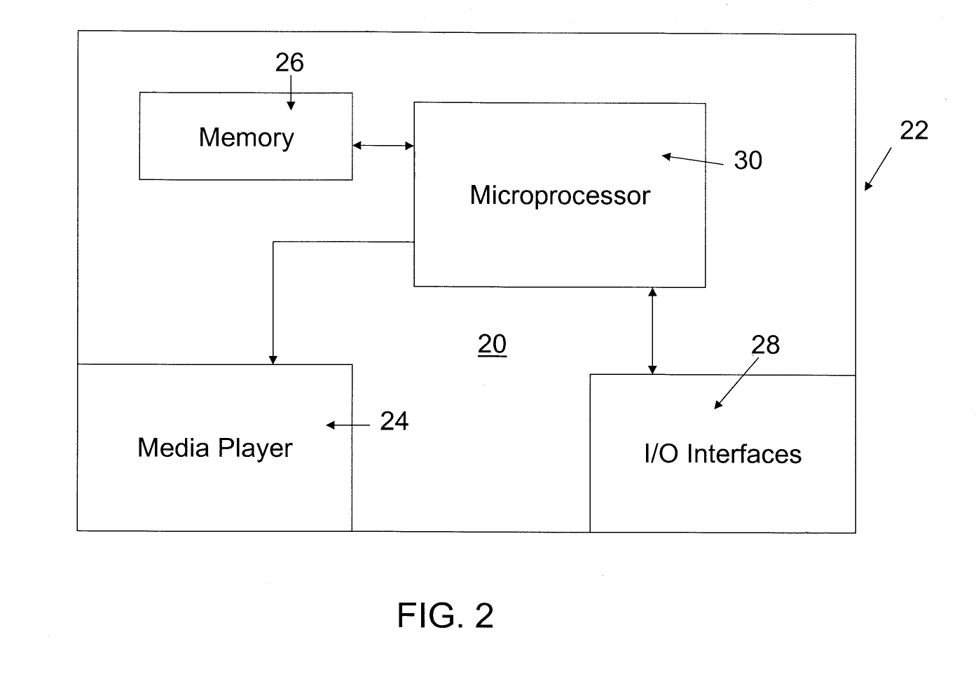

Clients 20 are provided to control the delivery and display of content obtained from server 14 through network 12. As used herein, the term “client” refers to a system that accesses content through a server, such as server 14, over a network, such as network 12. Referring to FIG. 2, one embodiment of a client may include a housing 22, a media player 24, a memory 26, one or more I/O interfaces 28 and a programmable microprocessor 30.

Housing 22 provides structural support to the components of client 20 and protection of the components of client 20 from external objects and elements. Housing 20 may be made from conventional metals and/or plastics. Housing 20 may be sized similar to a conventional “set-top” box used for delivery of cable television and/or the use of recordable media. In the embodiment illustrated in FIG. 2, display 18 is external to housing 22 and client 20 and its components are connected to display 18 through an I/O interface 28 such that client 20 can be used with existing televisions and display systems. It should be understood, however, that client 20 could alternatively be integrated with display 18 and the components of client 20 could be implemented in conventional display systems such as a televisions, laptop computers, PDAs, etc.

Media player 24 is provided to permit the user to read content from and record content to conventional forms of recordable media. Media player 24 may, for example, comprise a conventional DVD player.

Memory 26 provides local storage for content obtained from server 14 through network 12 (and possibly from recordable media through media player 24). Memory 26 may comprise an internal hard drive or other conventional form of memory. Memory 26 may be used by microprocessor 30 to implement one or more databases for storage of content. Such databases are conventional in the art and may be controlled using a conventional database management system. The organization of information within any given database will be dependent upon the type of content stored within the database and the intended use of that content.

I/O interfaces 28 are provided to allow connection of clients 20 with server 14, displays 18 and conventional I/O devices such as a remote control (not shown). Interfaces 28 may also allow for connection to devices capable of providing end use and other content such as a digital camera. Interfaces 28, therefore, may take on a variety of conventional forms depending on devices connected to client 20. Client 20 is configured to connect to server 14 over network 12. Accordingly, client 20 may include a conventional network interface card for connection to network 12. Client 20 may connect to network 12 using a wired or wireless connection (e.g., through use of an interface meeting the standards of IEEE 802.11 or a “Wi-Fi” device). Client 20 is also configured to communicate with display 18. In one constructed embodiment of the invention, client 20 is configured to output up to 8.1 channels of digital video and audio to display 18 and may also output analog video and audio.

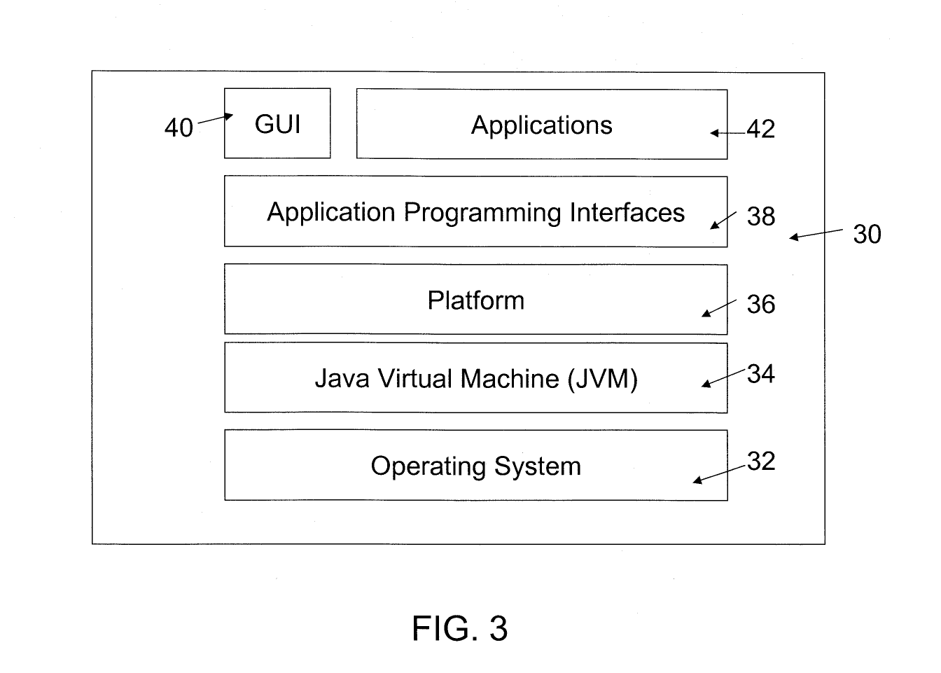

Microprocessor 30 is provided to control the operation of client 20 and its component parts. Referring to FIG. 3, microprocessor 30 may be programmed with programming instructions (i.e., software) to support and implement a system architecture including an operating system 32 and a virtual machine 34 (e.g., a Java Virtual Machine (JVM)). Microprocessor 30 may also be programmed to support and implement a basic platform 36 of software programs (e.g., specific commonly used operations and features) and application programming interfaces (APIs) 38 that may be accessed by other software programs resident in client 20 or downloaded from server 14 in order to perform various functions including, for example, the creation of graphical user interfaces (GUIs) and the manipulation of content. In one embodiment of the invention, platform 36 and APIs 38 may be used by content providers to develop software programs to implement GUIs and other functions particular to the content they wish to deliver. These programs may be located on server 14 and downloaded to client 20 upon request from client 20. Microprocessor 30 is further programmed to support and implement a graphical user interface 40 for client 20 and other applications 42 resident on client 20 or downloaded from server 14 through network 12. The client GUI 40 may, for example, be generated on, and accessed through, display 18 using a remote control or other device.

In accordance with the invention, client 20 (and microprocessor 30) may also include program code for performing functions associated with retrieval, display and use of content from server 14. As noted hereinabove, client 20 may request a wide variety of content from server 14. This content may include end use content such as audiovisual works (e.g., a movie, music video, etc.) or certain software programs (e.g., a game). The content may also include functional content useful for the retrieval, display, or other use of end use content or interaction with end use content. For example, a user of client 20 may retrieve a software application or program from server 14 for use in organizing digital photographs that are downloaded from server 14 or obtained from media player 24 or an I/O interface 28. A user of client 20 may also retrieve a software program from server 14 that permits interactive advertising or marketing of products wherein users can request and retrieve information about a product or can purchase a product and track the order or shipping status. A user of client 20 may also retrieve a software program from server 14 providing for feedback on end use content (e.g., the ability to express approval or disapproval of a television show or to vote for a contestant on a show).

In accordance with one aspect of the invention, providers of end use content will be able to provide software programs on server 14 adapted particularly for the delivery and use of their end use content. Using a GUI on client 20, the user will be able to identify available programs on server 14 and download a selected program (and preferably only those portions of the program that are required as discussed hereinbelow) for use in retrieving and using end use content. These programs will make use of the platform 36 on client 20 for greater programming efficiency. After use of the program, the client 20 preferably discards those portions of the program that have been downloaded (the program will remain available on server 14) and portions that have been created on client 20 through the program's invocation of programs from platform 36. In this manner, system 10 implements a software as a service (SaaS) model, except that the programs are run on client 20 rather than server 14. One advantage of this model is that it enables content providers to update the program, and users to obtain the most up to date version of the program, in a highly efficient manner (e.g., by eliminating the need for mass reproduction of updated programs on recordable media for distribution to users). Although the program is preferably discarded after use, client 20 may retain information about the program to implement a type of user preference functionality. For example, client 20 may retain sufficient information to generate an icon on the client GUI associated with the program to permit more rapid selection and retrieval during future use. Client 20 may also retain information regarding the state of the application to permit a user to resume an interrupted session. Client 20 may retain information in a database in memory 26.

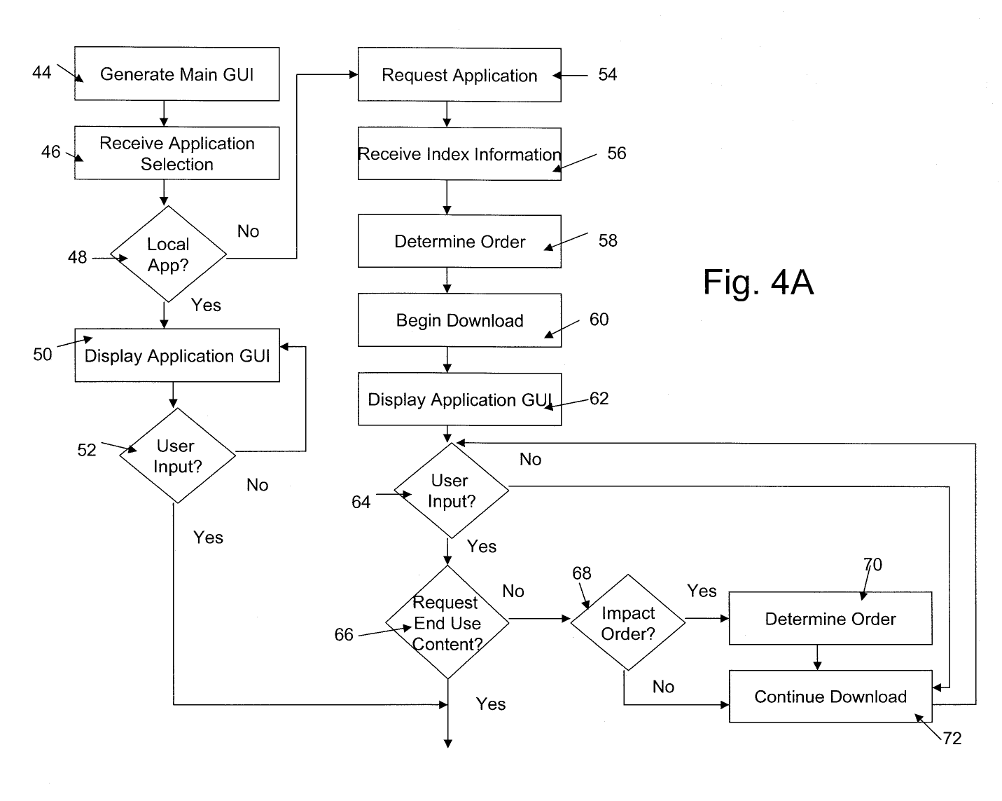

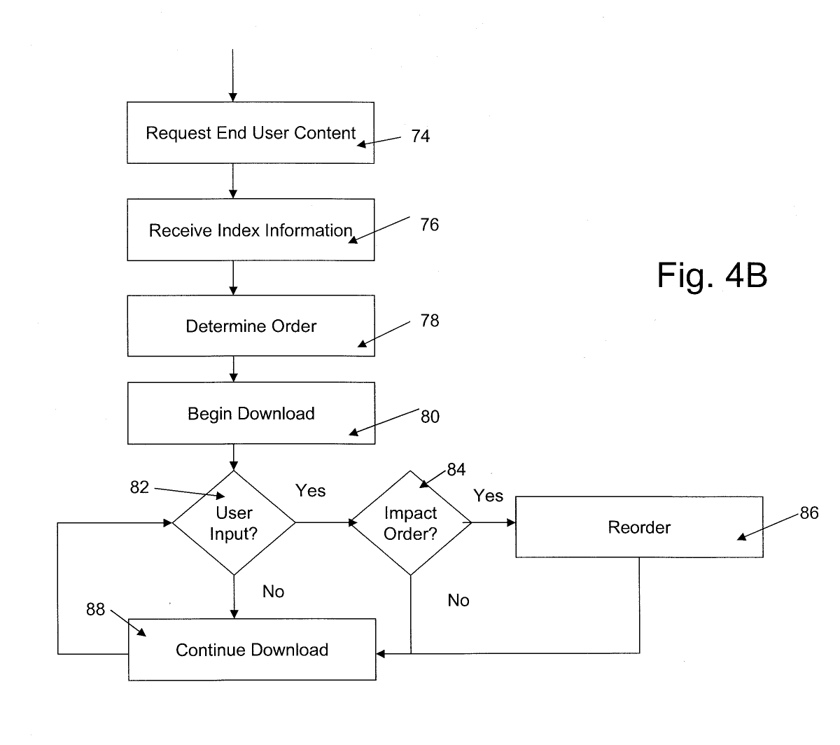

Referring to FIG. 4, the operation of a client 20 in accordance with one embodiment of the present invention is illustrated. It should be understood that client 20 may include program code for performing each of the steps illustrated in FIG. 4. It should also be understood that FIG. 4 illustrates only one embodiment of the invention and that the particular operations illustrated in FIG. 4, and the order of operations, may vary.

Client 20 may begin with the step 44 of generating a GUI for client 20 on display 18. The client GUI provides a mechanism for the user to interact with client 20 and control the function of client 20. The client GUI may, for example, enable a user to control the operation of media player 24 and to receive alerts regarding the connection status of client 20 with network 12, display 18 and external devices. The client GUI may also enable a user to select an application or software program available in client 20 or available for download from server 14 through network 12.

Client 20 may further be programmed to perform the step 46 of receiving an input from a user selecting an application available using client 20. This input may be received through the client GUI as noted above. Client 20 may be further programmed to perform the step 48 of determining whether the selected application is stored locally in memory 26 of client 20 or whether the selected application must be obtained from server 14.

If the selected application is stored locally in client 20, client 20 may perform the steps 50, 52 of displaying an application specific GUI and receiving an input from the user through the application specific GUI. The form and function of the application specific GUI will depend on the end use content for which the application is used. The GUI may again be implemented on and accessed through display 18. Client 20 is further configured to obtain the end use content responsive to the user input as described in greater detail hereinbelow.

If the selected application is stored remotely, client 20 may include program code for performing the step 54 of requesting the application, or content, from server 14. Content accessible by server 14 may be stored in the local memory of server 14 or remote from server 14 (e.g., in database 16) and will typically be stored as a plurality of related objects at discrete locations in the memory. In particular, a software program or application will typically include multiple files, modules or routines located at discrete locations in memory.

Client 20 may also include program code for performing the step 56 of receiving index information from server 14 regarding the content available from server 14. This index information may include the location or locations in memory of the content and the size of the content, for example. The index information may also include the version number of the application, the programming language, the author or authors of the application, the developer or owner of the application, contact information (e.g., for technical support), a rating, or any metadata associated with the application. The index information may be provided in an XML file.

Client 20 may further include program code for performing the step 58 of determining an order for requesting the plurality of objects making up the content from server 14 responsive to the index information. In the case of a software application or program, determining the order may be limited to determining the initial object of the program that should be downloaded (with the download of subsequent objects dependent on execution of the program). The initial object can be identified from the index information which will include the address for the start of the program. In one embodiment of the invention, the initial object will include program code for generating a user interface associated with the software program.

Client 20 may further include program code for performing the step 60 of requesting an initial object from the plurality of objects based on the order determined in step 58. As noted above, this object may be used by client 20 in step 62 to generate an application specific GUI. Step 62 preferably occurs simultaneous with a request and receipt by client 20 of another object from the plurality of objects making up the application content. As noted above, client 20 permits use of initially downloaded content by the user while remaining portions of the content are being downloaded. In this manner, the invention provides functionality similar to “streaming” content. The invention is advantageous relative to conventional streaming mechanisms, however, because the invention permits an ordered download of the associated files that enables the user to identify and view a location in the middle of a “stream” and also eliminates the need to download unneeded or unwanted portions of the “stream.” In the illustrated embodiment, client 20 continues to display the application specific GUI and receive inputs through the interface (step 62) while other portions or objects of the program are being downloaded.

Client 20 may further include program code for performing the step 64 of receiving a user input—which may be received through the application specific GUI for example—and for performing the step 66 of determining whether the user input is a request for end use content. As noted above, one example of a software program or application that could be obtained from server 14 is a program for viewing end use content in the form of photographs downloaded from server 14 or from a digital camera connected to client 20 through an I/O interface 28. The program may, for example, provide different modules/functions for selecting and viewing individual pictures and for placing the pictures into a slideshow for example. Using the application specific GUI through display 18, the user may select the option of viewing individual pictures or a slideshow. This user input would be treated as a request to implement another portion of the application as opposed to a request for end use content. As a result, client 20 may perform the step 68 of determining whether the user input impacts the order determined in step 58. For example, if the user selects a slideshow, the user will not need certain modules or functions associated with displaying the pictures for selection by the user or receiving an input making the selection. Client 20 may therefore perform the step 70 of ordering or reordering the objects to be requested such that files associated with these modules or functions are given low priority and either downloaded later in time or not at all.

Once the need to reorder the objects has been determined and any required reordering has occurred, client 20 may proceed with performing the step 72 of requesting another object from the plurality of objects based on the determined order. As noted above, the request and receipt of the additional object occurs while client 20 simultaneously generates output to display 18 based on the first object.

Once client 20 determines (step 66) that a request for end use content has been made, a similar sequence of steps occurs. Client 20 may therefore include program code for performing the step 74 of requesting the end use content from server 14. Content accessible by server 14 may again be stored in the local memory of server 14 or remote from server 14 (e.g., in database 16) and will typically be stored as a plurality of related objects at discrete locations in the memory. For example, the content on a DVD relating to a movie will typically be stored in multiple files of different file types and located at discrete locations in memory. One advantage of system 10 is that is that the memory limitations for end use content are virtually unlimited as compared to the inherent storage limitations of recordable media.

Client 20 may also include program code for performing the step 76 of receiving index information from server 14 regarding the content available from server 14. This index information may include, for example, the location or locations in memory of the content and the size of the content, the file or object names, and the file or object types among other information. In accordance with one embodiment of the invention, client 20 further includes program code for creating a template of the content. The template is built using the index information and is intended to provide a structure for storage and access of the content as it is downloaded from server 14. In one embodiment, upon a request for content, server 14 populates several arrays identifying large files, small files, and all of the files relating to the content (the difference in “large” and “small” being based on the size necessary to transfer in a predetermined minimum time period over an identified transfer rate over network 12). It should be understood as well that server 14 may also simply return a cached copy of this information on subsequent requests under the same operating conditions. Members in each array are created relating to individual files together with their file size. The template is created using the data in these arrays by, for example, creating a directory tree for the files. In one embodiment of the invention, the template replicates the file structure present on a DVD movie. Within the template, files are created matching the names for the files available through server 14 and the files are filled with dummy data up to a size matching the size of the corresponding file available through server 14.

Client 20 may further include program code for performing the step 78 of determining an order for requesting the plurality of objects making up the content from server 14 responsive to the index information. In the case of a DVD movie, for example, there are generally three types of files: .VOB files for video files, .IFO files containing information for navigating the files and .BUP files as a backup for the .IFO files. A typical naming convention identifies each title in a DVD movie by number and each associate file by another number. For example, files may be named in the format VTS_TITLE NUMBER_FILE NUMBER or, more specifically, VTS_{—}01_{—}0.VOB, VTS_{—}01_{—}1.VOB, etc. for one title associated with the DVD movie. Using index information such as the name and location of each file and the file type, client 20 may order the files for downloading. For example, with the knowledge that a FILE NUMBER of 0 identifies the menu for a given title, client 20 may order the files by giving the highest priority to the menu file for the first title. In this manner, client 20 may locate and order the files such that the menu file for the first title is downloaded first. Thereafter, while the user peruses the menu, client 20 can download the next file (e.g., VTS_{—}01_{—}1.VOB). Using index information such as the title number, the number of files for each title, the file number and/or the size of the files, client 20 can prioritize or order the files for download. In one embodiment, higher priority is given to smaller files (which typically includes the .IFO and .BUP files identified above).

In accordance with one embodiment of the invention, client 20 may also include program code for reevaluating the order for requesting the plurality of objects making up the content from server 14 responsive to information obtained from objects initially requested and received by client 20. In the case of the DVD movie described above, for example, information in the .IFO files (which include information about the .VOB files) can be used by client 20 to order the .VOB files for download. This methodology can be used, for example, to insure that the .VOB file containing the main menu is downloaded with a high priority even though it might not meet the original criteria for a high priority (e.g., because priority was based on size and the .VOB file containing the main menu is relatively large).

Client 20 may further include program code for performing the step 80 of requesting an initial object from the plurality of objects based on the order determined in step 78. In the case of the DVD movie, the initial object may be a .IFO file for example. The initial files will typically be used to generate a user interface on display 18 that will permit the user to select a feature of the DVD movie (e.g., play the movie, select a scene, adjust settings, etc.) This action will preferably occur simultaneous with a request and receipt by client 20 of another object from the plurality of objects making up the content. As noted above, client 20 permits use of initially downloaded content by the user while remaining portions of the content are being downloaded. In this manner, the invention provides functionality similar to “streaming” content. The invention is advantageous relative to conventional streaming mechanisms, however, because the invention permits an ordered download of the associated files that enables the user to identify and view a location in the middle of a “stream” and also eliminates the need to download unneeded or unwanted portions of the “stream.”

Client 20 may further include program code for performing the steps 82, 84 of determining whether a user input has been received and whether the user input impacts the order determined in step 78. In the case of a DVD movie again, a user may use a conventional scene selection portion of a GUI on display 18 to select a scene somewhere in the middle of a movie. As a result of the user input, client 20 may order or reorder the sequence of files to be downloaded to make download of a file including the scene a high, or higher, priority relative to other files. In this regard, client 20 may read information from the .IFO files responsive to the user input to identify the particular memory location within a .VOB file from which to begin downloading. Client 20 may therefore include program code for performing the step 86 of ordering or reordering the objects to be requested before performing the step 88 of requesting and receiving additional objects from the plurality of objects making up the content.

A content delivery system in accordance with the present invention has significant advantages relative to conventional systems. First, the inventive system enables delivery over a telecommunications network of the full spectrum of content and features associated with that content currently available only on recordable media. Second, the inventive system makes delivery of content more efficient by enabling transmission of only selected portions of content.

While the invention has been shown and described with reference to one or more particular embodiments thereof, it will be understood by those of skill in the art that various changes and modifications can be made without departing from the spirit and scope of the invention.

We claim:

1. A content delivery system, comprising:
a client configured for communication with a server and a display, said client including program code for
requesting content from said server, said content comprising a plurality of related objects at discrete locations in a memory accessible by said server;
receiving index information from said server regarding said content;
determining an order for requesting said plurality of objects from said server responsive to said index information;
requesting a first object of said plurality of objects based on said order; and,
requesting a second object of said plurality of objects based on said order while simultaneously generating output to said display based on said first object.

2. The content delivery system of claim 1 wherein said client further includes program code for generating a user interface; and, modifying said order responsive to an input through said user interface.

3. The content delivery system of claim 2 wherein said user interface is generated responsive to said first object.

4. The content delivery system of claim 1 wherein said order is determined responsive to file types of said objects.

5. The content delivery system of claim 1 wherein said order is determined responsive to file sizes of said objects.

6. The content delivery system of claim 1 wherein said order is determined responsive to file names of said objects.

7. The content delivery system of claim 1 wherein said order is determined responsive to functions associated with said objects.

8. The content delivery system of claim 1 wherein said first object includes program code for generating a user interface.

9. The content delivery system of claim 1, wherein said content comprises a software program.

10. The content delivery system of claim 9 wherein said software program includes code for requesting additional content from said server

11. The content delivery system of claim 1 wherein said content comprises an audiovisual work.

12. The content delivery system of claim 1 wherein said display comprises a television.

13. The content delivery system of claim 1 wherein said client further includes program code for creating a template for said content in a memory associated with said client.

14. The content delivery system of claim 1 wherein said client further includes program code for storing a set of information relating to said content after use of said content.
